(19) United States
(12) Patent Application Publication
(10) Pub. No.: US 2026/0347163 A1
(43) Pub. Date: Nov. 5, 2026

(54) AUTOMATIC FILLING DEVICE

(71) Applicant: Xuming Technology Co., Ltd., Miaoli County (TW)

(72) Inventor: KUO-SHENG LEE, Miaoli County (TW)

(21) Appl. No.: 19/356,183

(22) Filed: Oct. 12, 2025

(30) Foreign Application Priority Data
May 5, 2025 (TW) 114116709

(51) Int. Cl. B67C 3/34; B67C 3/20

(52) U.S. Cl. CPC B67C 3/34; B67C 3/202

(57) ABSTRACT

An automatic filling device includes a conveying module, an identification module, a rotating module, an opening and closing module, a supply module and a movable module. The conveying module is configured to carry and move at least one object storage container. The identification module is configured to identify the position of the object storage container. The rotating module is configured to contact and rotate the object storage container. The opening and closing module is configured to open or close the cover element of the object storage containers. The supply module is configured to supply the material to the object storage container. The movable module is configured to drive at least one of the opening and closing module and the supply module. Therefore, the automatic filling device can improve production efficiency and convenience, and can also prevent the raw materials from being contaminated.

### CROSS-REFERENCE TO RELATED PATENT APPLICATION

This application claims the benefit of priority to Taiwan Patent Application No. 114116709, filed on May 5, 2025. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an automatic filling device, and more particularly to automated material filling equipment.

### BACKGROUND OF THE DISCLOSURE

Generally, when producing chemical raw material barrels, most of the empty barrels are operated manually. That is to say, the prior method is to manually remove the lid on the filling port of the empty chemical raw material barrel, and then align the filling port of the empty chemical raw material barrel with the chemical raw material filling device. After the chemical raw material is filled into the empty chemical raw material barrel, the lid is locked on the filling port of the filled chemical raw material barrel.

However, the above method is not only cumbersome to operate and has high production costs, but also more likely to contaminate the chemical raw materials in the chemical raw material barrel.

### SUMMARY OF THE DISCLOSURE

In response to the above-referenced technical inadequacy, the present disclosure provides an automatic filling device.

In order to solve the above-mentioned problems, one of the technical aspects adopted by the present disclosure is to provide an automatic filling device, which includes a conveying module, an identification module, a rotating module, an opening and closing module, a supply module and a movable module. The conveying module is configured to carry at least one object storage container and move the at least one object storage container. The identification module is suspended above the conveying module, and the identification module is configured to identify a position of the at least one object storage container. The rotating module is adjacent to the conveying module, and the rotating module is configured to contact and rotate the at least one object storage container. The opening and closing module is configured as a cover element to open or close the at least one object storage container. The supply module is configured to supply at least one material to the at least one object storage container. The movable module is adjacent to the conveying module and connecting to the opening and closing module and the supply module, and the movable module is configured to move at least one of the opening and closing module and the supply module.

Therefore, one of the beneficial effects of the present disclosure is that the automatic filling device provided by the present disclosure can improve production efficiency and convenience through the above-mentioned technical solution, and can also prevent raw materials from being contaminated by operators.

These and other aspects of the present disclosure will become apparent from the following description of the embodiment taken in conjunction with the following drawings and their captions, although variations and modifications therein may be effected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a schematic front view of an automatic filling device according to an embodiment of the present disclosure;

FIG. 2 is a schematic perspective view of the automatic filling device according to the embodiment of the present disclosure;

FIG. 3 is a schematic side view of the automatic filling device according to the embodiment of the present disclosure;

FIG. 4 is a schematic top view of the automatic filling device according to the embodiment of the present disclosure; and

FIG. 5 is a functional block diagram of the automatic filling device according to the embodiment of the present disclosure.

### DETAILED DESCRIPTION OF THE EXEMPLARY EMBODIMENTS

The present disclosure is more particularly described in the following embodiments and examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

### Embodiments

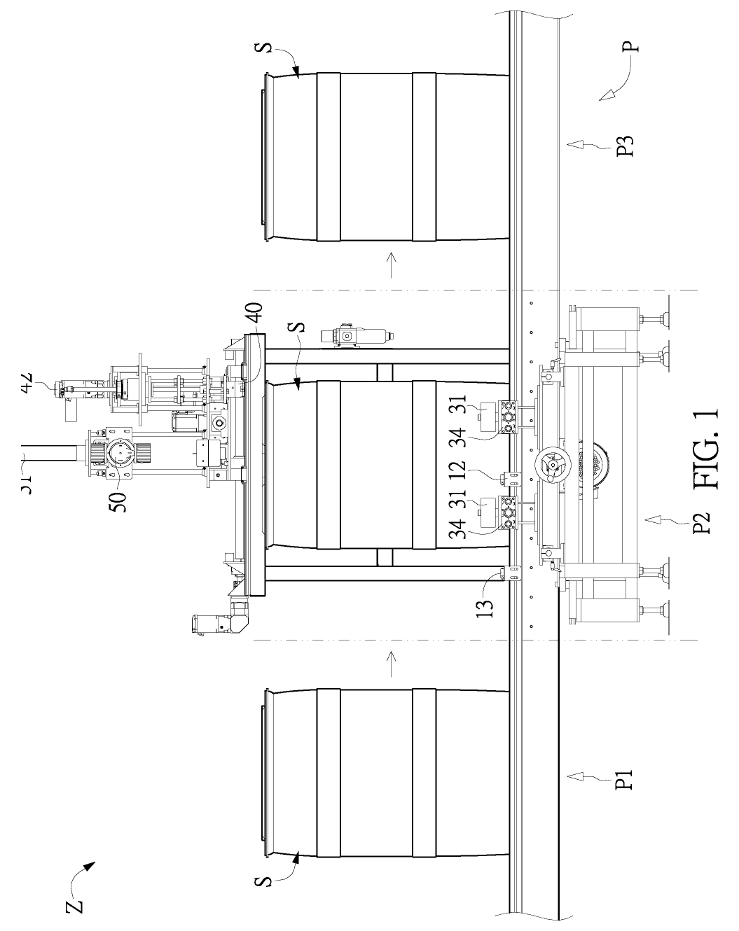

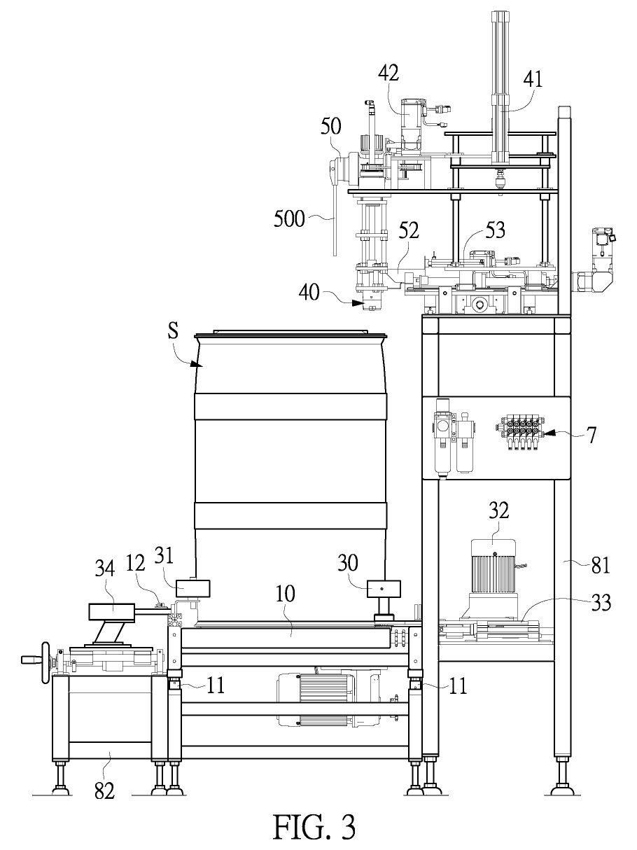

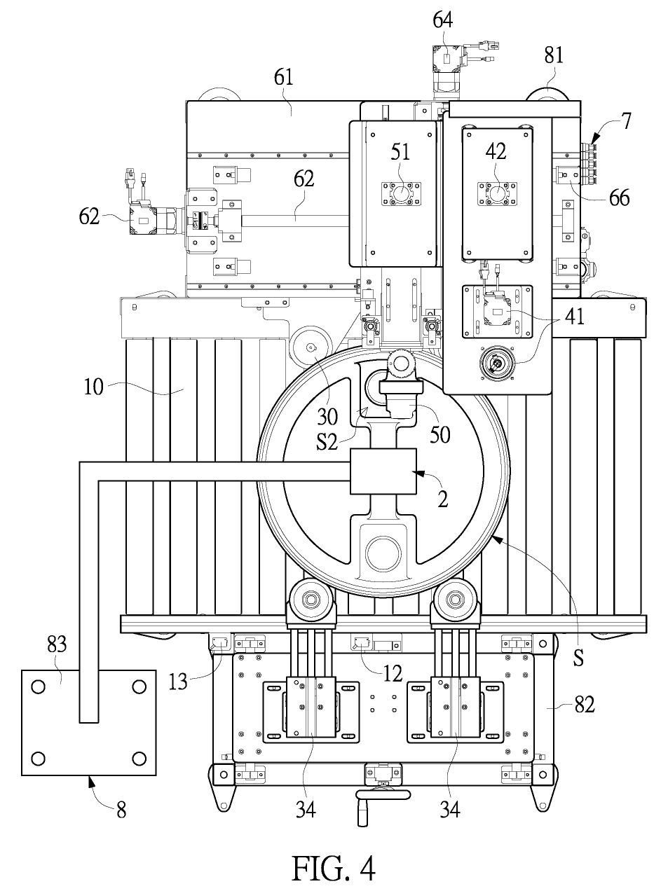

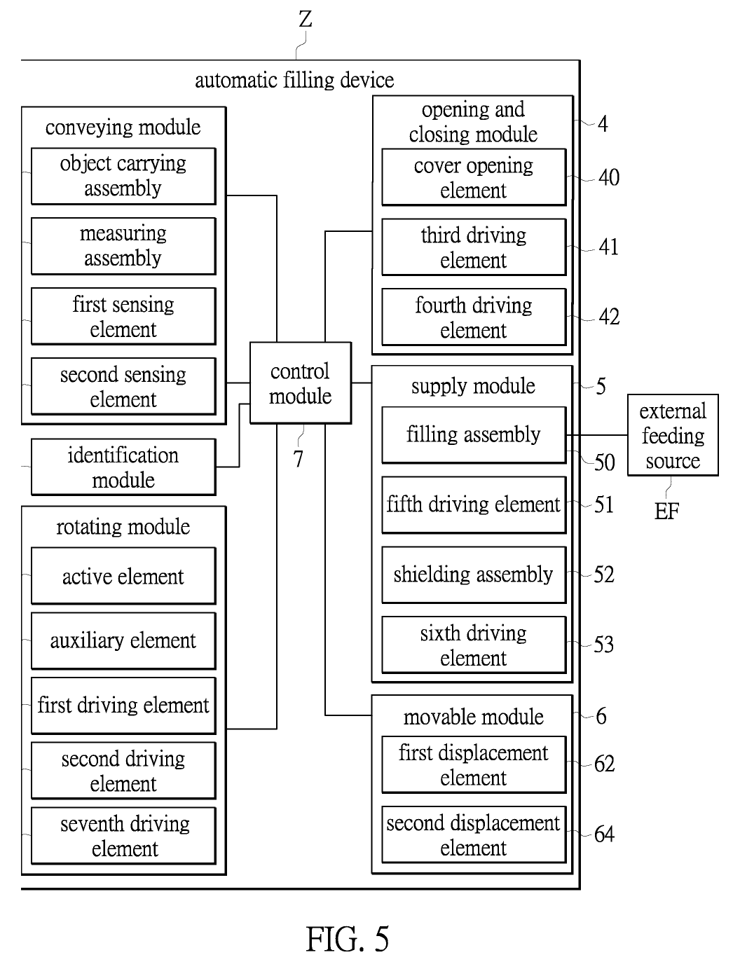

Referring to FIGS. 1-5, an embodiment of the present disclosure provides an automatic filling device Z for any type of containers (such as drums, bottles, pails, cans, or intermediate bulk containers), which may include a conveying module 1 (or a transporting module, such as a conveyor belt or a conveyor roller), an identification module 2, a rotating module 3, an opening and closing module 4, a supply module 5, and a movable module 6.

As shown in FIGS. 1-5, the conveying module 1 can be configured to carry and move at least one object storage container S (such as drum, bottle, pail, can, intermediate bulk container (IBC) or any type of container). For example, the conveying module 1 may be a production line conveying device, and the conveying module 1 may have a conveying path P. The conveying path P may include a placement section P1 (or preparation section before filling), a filling section P2 (or filling section during filling), and a completed filling sectionP3 (or completion section after filling), and the filling sectionP2 can be located between and connected to the placement section P1 and the completed filling section P3, in which the identification module 2, the rotating module 3, the opening and closing module 4, and the supply module 5 can correspond to the filling section P2. More particularly, the conveying module 1 may include an object carrying assembly 10 (or object supporting assembly), a measuring assembly 11, a first sensing element 12, and a second sensing element 13. The object carrying assembly 10 may be a power roller or a conveying device (such as a conveying table, but the present disclosure is not limited thereto), and the object carrying assembly 10 can be configured to carry at least one object storage container S and drive at least one object storage container S to move. The identification module 2, the opening and closing module 4, and the supply module 5 can be suspended or disposed above the object carrying assembly 10, and the rotating module 3 can be adjacent to the object carrying assembly 10. The measuring assembly 11 may be a weight measuring device (such as a load cell or an electro-mechanical sensor used to measure force or weight), and the measuring assembly 11 can be connected to the object carrying assembly 10 (for example, the measuring assembly 11 can be combined with the object carrying assembly 10, or the measuring assembly 11 can be disposed below the object carrying assembly 10), and the measuring assembly 11 can be configured to measure a weight (i.e., the overall weight) of the at least one object storage container S. The first sensing element 12 and the second sensing element 13 may be object sensors or any type of detectors. The first sensing element 12 can be located at the center of one side of the object carrying assembly 10 and configured to detect whether the at least one object storage container S approaches the rotating module 3. The second sensing element 13 can be located at one end of one side of the object carrying assembly 10 and configured to detect whether the at least one object storage container S approaches the filling section P2.

Next, as shown in FIGS. 1-5, the identification module 2 can be suspended above the conveying module 1 and configured to identify the position of the at least one object storage container S. For example, the identification module 2 may be an image recognition device and can be suspended above the object carrying assembly 10. The identification module 2 can be used to capture an image of the object storage container S to identify the current position of the object storage container S.

Next, as shown in FIGS. 1-5, the rotating module 3 can be located adjacent to the conveying module 1 and configured to contact and rotate the at least one object storage container S. For example, the rotating module 3 may include a plurality of active elements 30, a plurality of auxiliary elements 31, a first driving element 32, and a second driving element 33. The active elements 30 can be movably disposed on one side of the conveying module 1 and can be configured to contact and rotate the at least one object storage container S. The auxiliary elements 31 can be movably disposed on another side of the conveying module 1 and can be configured to contact the at least one object storage container S. The active elements 30 and the auxiliary elements 31 may be guide wheel assemblies. The first driving element 32 can be connected to the active elements 30 and can be configured to drive the at least one active element 30 to rotate. The first driving element 32 may be a drive motor or any type of driving device. The second driving element 33 can be connected to the active elements 30 and can be configured to drive the active elements 30 toward or away from the at least one object storage container S. The second driving element 33 may be a telescopic pneumatic cylinder or any type of telescopic device.

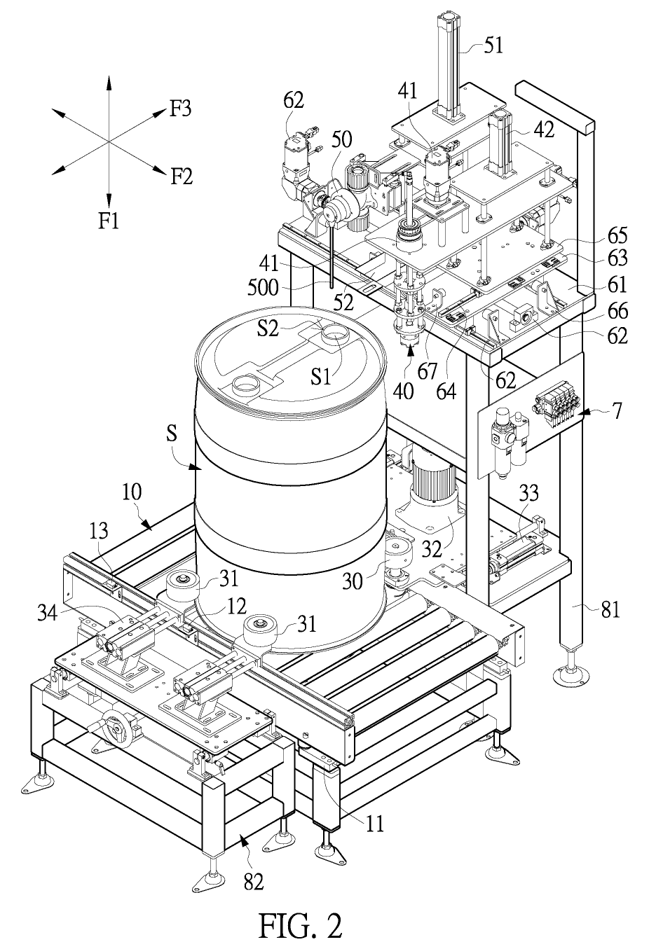

Next, referring to FIGS. 2-5, the opening and closing module 4 can be configured to open or close (lock) a cover element S1 of the at least one object storage container S. For example, the opening and closing module 4 may be a pick-and-place device for taking the cover element S1 (such as a lid) away from the object storage container S (or for getting the cover element S1 off the object storage container S) by suction, clamping or any taking means, or for taking the cover elementS1 to close or enclose the object storage container S. The opening and closing module 4 may include a cover opening element 40 (such as a lid opening element), a third driving element 41 and a fourth driving element 42. The cover opening element 40 can be adjacent to the conveying module 1, and the cover opening element 40 may be a clamp or any type of clamping mechanism. The third driving element 41 can be connected to the cover opening element 40, and the third driving element 41 can be configured to drive the cover opening element 40 to open or lock the cover element S1 of the at least one object storage container S. The third driving element 41 may be a servo motor or any type of drive device. The fourth driving element 42 can be connected to the third driving element 41 and the movable module 6. The fourth driving element 42 can be configured to drive the third driving element 41 to reciprocate in a first direction F1, thereby moving the cover opening element 40 toward or away from at least one object storage container S. For example, the fourth driving element 42 can be configured to drive the third driving element 41 to move in the vertical direction. The fourth driving element 42 may be a telescopic pneumatic cylinder or any type of telescopic device.

Next, as shown in FIGS. 1-5, the supply module 5 can be configured to supply at least one material to the at least one object storage container S. For example, the supply module 5 may include at least one filling assembly 50 and at least one fifth driving element 51. The filling assembly 50 may be a fluid supply valve or any type of fluid conveying assembly. The filling assembly 50 can be connected to an external feeding source EF (such as a chemical raw material supply device, but the present disclosure is not limited thereto). The at least one filling assembly 50 can be configured to supply at least one material (such as a fluid chemical raw material, but the present disclosure is not limited thereto) to the at least one object storage container S. The filling assembly 50 may have an injection element 500 (or an injection part, or an injector), which may be a tubular structure. The fifth driving element 51 may be a pneumatic cylinder or any type of lifting module. The fifth driving element 51 can be connected to the movable module 6. The fifth driving element 51 can be configured to drive the filling assembly 50 toward or away from a filling opening S2 of the object storage container S. The fifth driving element 51 can correspond to drive one filling assembly 50, or a plurality of filling assemblies 50. Furthermore, the filling assembly 50 can be configured to transmit the material supplied by the external feeding source EF to the at least one object storage container S. In addition, the supply module 5 may also include at least one shielding assembly 52 and at least one sixth driving element 53. The shielding assembly 52 may be a ladle-shaped assembly or any type of carrier assembly. The shielding assembly 52 is adjacent to the filling assembly 50 and connected to the sixth driving element 53. The sixth driving element 53 may be a pneumatic cylinder or any type of lifting module. The sixth driving element 53 can be connected to the shielding assembly 52 and movably connected to the movable module 6. The sixth driving element 53 can be configured to drive the shielding assembly 52 toward or away from the injection element 500 of at least one filling assembly 50. The sixth driving element 53 can correspond to drive one shielding assembly 52 or a plurality of shielding assemblies 52. It is worth noting that in this embodiment, the number of each of the filling assembly 50, the fifth driving element 51, the shielding assembly 52, and the sixth driving element 53 is taken as one as an example, but the number is not limited to this. In actual application, the number of each of the above assemblies can also be multiple.

Next, as shown in FIGS. 1-5, the movable module 6 can be adjacent to the conveying module 1 and connected to the opening and closing module 4 and the supply module 5. The movable module 6 can be configured to drive at least one of the openings and closing module 4 and the supply module 5. For example, the movable module 6 may include a first carrier element 61 (or a first support element), a first displacement element 62, a second carrier element 63 (or a second support element), a second displacement element 64 and a third carrier element 65 (or a third support element). Each of the first carrier element 61, the second carrier element 63 and the third carrier element 65 may be a single-layer plate or a multi-layer frame structure. The first displacement element 62 and the second displacement element 64 may be linear slides, ball screws or any types of movable modules, but the present disclosure is not limited thereto. The first carrier element 61 can be adjacent to the conveying module 1. For example, the first carrier element 61 can be located beside or adjacent to one side of the object carrying assembly 10. The first displacement element 62 can be movably disposed on the first carrier element 61. The second carrier element 63 can be connected to the first displacement element 62. The first displacement element 62 can be configured to drive the second carrier element 63 to perform reciprocating displacement in a second direction F2 (to move back and forth in a second direction F2). For example, the first displacement element 62 can be configured to drive the second carrier element 63 to move horizontally in a front-back (forward-backward) or left-right direction. The second displacement element 64 can be movably disposed on the second carrier element 63. The third carrier element 65 can be connected to the second displacement element 64, the opening and closing module 4, and the supply module 5. The second displacement element 64 can be configured to drive the third carrier element 65 to perform reciprocating displacement in a third direction F3. For example, the second displacement element 64 can be configured to drive the third carrier element 65 to move horizontally in a forward-backward or left-right direction. The first direction F1, the second direction F2, and the third directionF3 are different from each other. For example, the second direction F2 can be an X-axis direction, and the third direction F3 can be a Y-axis direction. The second direction F2 and the third direction F3 are perpendicular to or intersecting with each other, but the present disclosure is not limited thereto.

It is worth noting that the movable module 6 of the present disclosure may also include at least one first stop element 66 and at least one second stop element 67. The first stop element 66 can be disposed on the first carrier element 61 and located beside one side of the second carrier element 63, and the first stop element 66 can be configured to stop the second carrier element 63 to prevent the displacement of the first displacement element 62 for driving the second carrier element 63 from exceeding the range of the displacement of the first displacement element 62. The second stop element 67 can be disposed on the second carrier element 63 and located beside one side of the third carrier element 65, and the second stop element 67 can be configured to stop the third carrier element 65 to prevent the displacement of the second displacement element 64 for driving the third carrier element 65 from exceeding the range of the displacement of the second displacement element 64.

Therefore, as shown in FIGS. 1-5, during operation of the automatic filling device Z of the present disclosure, an operator or a mechanical device may place at least one object storage container S on the placement section P1 of the object carrying assembly 10, and then the object storage container S can be moved from the placement sectionP1 to the filling section P2 of the object carrying assembly 10 through the object carrying assembly 10.

Next, when the at least one object storage container S is moved to the filling section P2 through the conveying module 1, the second sensor 13 can be configured to detect whether the object storage container S is ready or entering the filling sectionP2. If the object storage container S is ready or entering the filling section P2, the second sensor 13 can be configured to provide a feedback signal to the object carrying assembly 10, causing the object carrying assembly 10 to slow down the speed of conveying the object storage container S. After the object storage container S enters the filling section P2, the first sensor 12 can be configured to detect whether the object storage container S is located between the active elements 30 and the auxiliary elements 31. If the object storage container S is located between the active elements 30 and the auxiliary elements 31, the first sensor 12 can be configured to provide a feedback signal to the object carrying assembly 10, causing the object carrying assembly 10 to stop conveying the object storage container S. Furthermore, the second driving element 33 can be configured to drive the active elements 30 to approach and contact the object storage container S, thereby clamping the object storage container S through the active elements 30 and the auxiliary elements 31.

Next, the identification module 2 can be configured to identify whether the at least one object storage container S has a filling opening S2, and one or more filling openings S2 can be provided on the top of the object storage container S. The present disclosure can determine whether the current position of the object storage container S is in a ready-to-fill position (waiting-to-fill position) or a non-filling position by determining whether the identification module 2 is configured to identify that the object storage container S has a filling opening S2. For example, when the identification module 2 does not identify (or recognize) that the object storage container S has a filling opening S2, it is determined that the current position of the object storage container S is in a non-filling position. When the current position of the object storage container S is in the non-filling position, the first driving element 32 of the rotating module 3 can be configured to drive at least one active element 30 to rotate, thereby driving the at least one active element 30 to drive the object storage container S to perform a rotational motion (i.e., rotation in place) until the identification module 2 can identify that the object storage container S has a filling opening S2(that is to say, the identification module 2 can be configured to continue to identify the object storage container S). In addition, when the identification module 2 can identify that the object storage container S has a filling opening S2, it is determined that the current position of the object storage container S is in a ready-to-fill position, and the first driving element 32 can be configured to stop driving the at least one active element 30 to rotate.

When the object storage container S is in the ready-to-fill position, the first displacement element 62 and the second displacement element 64 of the movable module 6 can be controlled to drive the opening and closing module 4 to open the cover element S1 (such as the lid). The first displacement element 62 can be configured to drive the second carrier element 63 to move in the second direction F2, and the second displacement element 64 can be configured to drive the third carrier element 65 to move in the third direction F3. The first displacement elements 62 and the second displacement element 64 may be activated or moved simultaneously or sequentially. The second carrier element 63 and the third carrier element 65 can be configured to drive or move the cover opening element 40 from an initial position to a cover rotating position. The cover rotating position can be located above the filling opening S2 of the object storage container S and correspond to the filling opening S2 of the object storage container S. The fourth driving element 42 of the opening and closing module 4 can be configured to drive the third driving element 41 to move in the first direction F1, so that the third driving element 41 can be allowed to move the cover opening element 40 to close to the top surface of the object storage container S and contact the cover element S1 on the filling opening S2 (for example, by grabbing or grasping the cover element S1, or sucking the cover element S1, but the present disclosure is not limited thereto). Next, the third driving element 41 can be configured to drive the cover opening element 40 to open the filling opening S2. In this embodiment, the cover opening element 40 can be configured to take the cover element S1 away by rotating the cover element S1, but the present disclosure is not limited thereto. In actual implementation, the cover element S1 can be removed from the filling opening S2 by any other method. Thereafter, the fourth driving element 42 can be configured to further drive the third driving element 41 to move in the first direction F1, thereby indirectly driving the cover opening element 40 holding the cover element S1 to move away from the top surface of the object storage container S.

Next, the first displacement elements 62 and the second displacement element 64 of the movable module 6 can be configured again to drive the supply module 5 to perform a filling operation. The first displacement element 62 can be configured to drive the second carrier element 63 to displace or move in the second direction F2, and the second displacement element 64 can be configured to drive the third carrier element 65 to displace or move in the third direction F3. The second carrier element 63 and the third carrier element 65 can be configured to drive the filling assembly 50 from an initial position to a material injection position. The material injection position can be located above the filling opening S2 of the object storage container S and correspond to the filling opening S2 of the object storage container S, and the cover opening element 40 can return from the cover rotating position to the initial position or other positions (such as any position other than the cover rotating position). Next, the fifth driving element 51 of the supply module 5 can be configured to drive the filling assembly 50 toward the filling opening S2 of the object storage container S so as to allow the injection element 500 to be inserted into the filling opening S2. The displacement direction of the filling assembly 50 can be the same as the displacement direction (i.e., the first direction F1) of the cover opening element 40. Next, the filling assembly 50 can be configured to fill the object storage container S with filling materials (or fill the filling materials into the object storage container S). During the process of filling the filling assembly 50 with filling materials, the measuring assembly 11 can be configured to intermittently or continuously measure the weight of the object storage container S. When the measuring assembly 11 can be configured to determine that the current weight of the object storage container S is equal to a predetermined weight (such as 5 kg, but the present disclosure is not limited thereto), the filling assembly 50 can stop feeding filling materials to the object storage container S. Furthermore, the fifth driving element 51 can be configured to drive the filling assembly 50 to move away from the filling opening S2 of the object storage container S, so that the injection element 500 can be separated and moved away from the filling opening S2. Simultaneously, the sixth driving element 53 can be configured to drive the shielding assembly 52 to move from a standby position (i.e., a position away from the injection element 500, or a position without corresponding to the injection element 500) to a material receiving position. When the shielding assembly 52 is in the material receiving position, the shielding assembly 52 can be located below the injection element 500 and between the injection element 500 and the object storage container S, thereby preventing the residual material on the injection element 500 from dripping onto the object storage container S.

Next, the first displacement elements 62 and the second displacement element 64 of the movable module 6 can be configured again to drive the opening and closing module 4 to lock the cover element S1 (such as enclosing the filling opening S2 by the cover element S1), and the specific operation method is as described above and will not be repeated here. Therefore, the cover opening element 40 can be moved to the rotating position through the displacement of the second third support element 63 and the third support element 65. At the same time, the filling assembly 50 can return from the injection position to the original position or another position (such as any position other than the injection position), and the shielding assembly 52 can be driven by the sixth driving element 53 from the material receiving position back to the standby position. Next, the fourth driving element 42 can be configured to drive the third driving element 41 to move in the first direction F1, and the third driving element 41 can be configured to drive the cover opening element 40 to clamp or hold the cover element S1 to approach the top surface of the object storage container S, and then close or enclose the filling opening S2 by the cover element S1. Furthermore, the third driving element 41 can be configured to drive the cover opening element 40 to tightly engage or connect the cover element S1 to the filling opening S2, thereby sealing the object storage container S. Afterwards, the fourth driving element 42 can be configured to drive the third driving element 41 to move in the first direction F1, thereby indirectly driving the cover opening element 40 away from the top surface of the object storage container S.

Next, the second driving element 33 of the rotating module 3 can be configured to drive the active elements 30 away from the object storage containers S. Thereafter, the object carrying assembly 10 of the conveying module 1 can be configured to drive the object storage containers S to move to the completed filling section P3 for subsequent processing (such as shipping or other processes).

It should be noted that the aforementioned modules can be directly or indirectly electrically connected to each other. Therefore, when one module stops or completes its operation, the following module can proceed with the subsequent process or procedure.

Therefore, according to the aforementioned technical solution, the automatic filling device Z of the present disclosure can utilize the conveying module 1, the identification module 2, the rotating module 3, the opening and closing module 4, and the supply module 5 to enable the chemical raw material barrel to be changed from an empty barrel state to a chemical raw material filled state, and the chemical raw material filling process does not require human operation. It not only improves accuracy and avoids contamination of raw materials, but also significantly reduces production costs.

Furthermore, the automatic filling device Z of the present disclosure may also include a control module 7, which is connected to the conveying module 1, the identification module 2, the rotating module 3, the opening and closing module 4, the supply module 5, and the movable module 6. The control module 7 can be configured to activate or deactivate at least one of the conveying modules 1, the identification module 2, the rotating module 3, the opening and closing module 4, the supply module 5, and the movable module 6.

For example, as shown in FIGS. 1-3, the automatic filling device Z of the present disclosure may also include the control module 7. The control module 7 may be a pneumatic control device, an electric control device or a combination thereof, or may be an electronic device or a remote electronic device located in a backend control center. Therefore, when the operation of one of the modules stops or is completed, the control module 7 can receive the relevant information and drives the subsequent module to proceed with the subsequent process or flow. For example, the control module 7 can be configured to drive the object carrying assembly 10 to move the object storage container S to the filling section P2 and control the identification module 2 to identify whether the object storage container S is present in the filling section P2 (or whether there is the object storage container S in the filling section P2). When the identification module 2 can identify that there is the object storage container S in the filling section P2, the control module 7 can control the active elements 30 of the rotating module 3 to contact and abut against the object storage container S. The subsequent process can refer to the above content and will not be further described here.

Furthermore, the automatic filling device Z of the present disclosure may also include a support module 8 (or a bracket module), which may include a first support element 81, a second support element 82, and a third support element 83. The first support element 81, the second support element 82, and the third support element 83 can be configured as a support frame structure. The first support element 81 can be located beside one side of the object carrying assembly 10, the second support element 82 can be located beside another side of the object carrying assembly 10, and the third support element 83 can be adjacent to the object carrying assembly 10. The active elements 30, the first driving element 32, the second driving element 33 and the movable module 6 can be disposed on the first support element 81, the auxiliary elements 31 can be disposed on the second support element 82, and the identification module 2 can be disposed on the third support element 83.

It is worth noting that the rotating module 3 of the present disclosure may also include a plurality of seventh driving elements 34, which may be telescopic pneumatic cylinders or any type of telescopic devices. The seventh driving elements 34 can be disposed on the second support module 8, and each seventh driving element 34 can correspond to one of the auxiliary elements 31. Each seventh driving element 34 can be configured to drive the corresponding auxiliary element 31 toward or away from the object carrying assembly 10 (or object storage container S).

It is worth noting that the body of the object storage container S may have at least one predetermined pattern, such as a QR code or any type of pattern. The supply module 5 of the present disclosure may include a plurality of filling assemblies 50, and each filling assembly 50 can be correspondingly connected to a different external feeding source EF. Therefore, during the filling process, the identification module 2 can be configured to identify a preset pattern and then generate identification information in advance. Based on the identification information, the control module 7 can be configured to drive the fifth driving element 51 to drive one of the filling assemblies 50 toward the object storage container S to supply the material corresponding to the preset pattern into the object storage container S. Alternatively, the control module 7 can be configured to drive one or more fifth driving elements 51 to drive the filling assemblies 50 to sequentially supply different materials into the same object storage container S.

However, the above example is merely one possible embodiment and is not intended to limit the present disclosure.

### Beneficial Effects of the Embodiments

In conclusion, one of the beneficial effects of the present disclosure is that the automatic filling device provided by the present disclosure can improve production efficiency and convenience through the above-mentioned technical solution, and can also prevent raw materials from being contaminated by operators.

Furthermore, the automatic filling device Z provided by the present disclosure can utilize the above-mentioned technical solution to set up the conveying module 1, the identification module 2, the rotating module 3, the opening and closing module 4, and the supply module 5, so that the chemical raw material barrel can be changed from an empty barrel state to a filled barrel state without human operation. This can not only improve accuracy and avoid contamination of raw materials, but also significantly reduce production costs.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. An automatic filling device, comprising:
a conveying module configured to carry at least one object storage container and move the at least one object storage container;
an identification module suspended above the conveying module, wherein the identification module is configured to identify a position of the at least one object storage container;
a rotating module adjacent to the conveying module, wherein the rotating module is configured to contact and rotate the at least one object storage container;
an opening and closing module configured as a cover element to open or close the at least one object storage container;
a supply module configured to supply at least one material to the at least one object storage container; and
a movable module adjacent to the conveying module and connecting to the opening and closing module and the supply module, wherein the movable module is configured to move at least one of the opening and closing module and the supply module.

2. The automatic filling device according to claim 1,
wherein the conveying module has a conveying path including a placement section, a filling section, and a completed filling section, and the identification module, the rotating module, the opening and closing module, and the supply module correspond to the filling section;
wherein, when the conveying module is configured to drive the at least one object storage container to move to the filling section, the identification module is configured to identify whether the at least one object storage container has a filling opening;
wherein, when the identification module does not identify the at least one object storage container having the filling opening, the rotating module is configured to drive the at least one object storage container to rotate; and
wherein, when the identification module identifies the at least one object storage container having the filling opening, the rotating module is configured to stop driving the at least one object storage container to rotate.

3. The automatic filling device according to claim 1, wherein the conveying module includes:
an object carrying assembly configured to carry the at least one object storage container and move the at least one object storage container; and
a measuring assembly connected to the object carrying assembly, wherein the measuring assembly is configured to measure a weight of the at least one object storage container;
wherein the identification module, the opening and closing module, and the supply module are suspended above the object carrying assembly, and the rotating module is adjacent to the object carrying assembly.

4. The automatic filling device according to claim 3, wherein, when the supply module is configured to supply the at least one material to the at least one object storage container and the weight of the at least one object storage container measured by the measuring assembly equals to a predetermined weight, the supply module is configured to stop supplying the at least one material to the at least one object storage container.

5. The automatic filling device according to claim 1, wherein the rotating module includes:
a plurality of active elements movably disposed on one side of the conveying module, wherein the active elements are configured to contact and rotate the at least one object storage container;
a plurality of auxiliary elements movably disposed on another side of the conveying module, wherein the auxiliary elements are configured to contact the at least one object storage container;
a first driving element connected to the active elements, wherein the first driving element is configured to drive at least one of the active elements to rotate; and
a second driving element connected to the active elements, wherein the second driving element is configured to drive the active elements toward or away from the at least one object storage container.

6. The automatic filling device according to claim 1, wherein the opening and closing module includes:
a cover opening element;
a third driving element connected to the cover opening element, wherein the third driving element is configured to drive the cover opening element to open or close the cover element of the at least one object storage container; and
a fourth driving element connected to the third driving element and the movable module, wherein the fourth driving element is configured to drive the third driving element to move in a first direction to move the cover opening element toward or away from the at least one object storage container.

7. The automatic filling device according to claim 1, wherein the supply module includes:
at least one filling assembly configured to supply the at least one material to the at least one object storage container; and
at least one fifth driving element connected to the movable module, wherein the at least one fifth driving element is configured to drive the at least one filling assembly toward or away from a filling opening of the object storage container.

8. The automatic filling device according to claim 7, wherein the supply module further includes:
at least one shielding assembly; and
at least one sixth driving element connected to the at least one shielding assembly and movably connected to the movable module, wherein the at least one sixth driving element is configured to drive the at least one shielding assembly toward or away from an injection element of the at least one filling assembly.

9. The automatic filling device according to claim 1, wherein the movable module includes:
a first carrier element adjacent to the conveying module;
a first displacement element movably disposed on the first carrier element;
a second carrier element connected to the first displacement element;
a second displacement element movably disposed on the second carrier element; and
a third carrier element connected to the second displacement element, the opening and closing module, and the supply module;
wherein the first displacement element is configured to move the second carrier element in a second direction;
wherein the second displacement element is configured to move the third carrier element in a third direction; and
wherein the second direction is different from the third direction.

10. The automatic filling device according to claim 1, further comprising a control module connected to the conveying module, the identification module, the rotating module, the opening and closing module, the supply module and the movable module, wherein the control module is configured to drive at least one of the conveying module, the identification module, the rotating module, the opening and closing module, the supply module and the movable module to operate or stop operating.
